(19) United States
(12) Patent Application Publication
(10) Pub. No.: US 2026/0359798 A1
(43) Pub. Date: Nov. 12, 2026

(54) SYSTEM AND METHOD FOR AUTOMATED GENERATION OF A DATA TRANSFER FILE

(71) Applicant: The Toronto-Dominion Bank, Toronto (CA)

(72) Inventors: Nachiket KULKARNI, Mississauga (CA); Isaac Brendon ROZARIO, Whitby (CA); Mohamed ABDULNASSIR, Mississauga (CA); Mohanalakshmi Sai Himabindu KOPPELLA, Scarborough (CA)

(21) Appl. No.: 19/203,844

(22) Filed: May 9, 2025

(51) Int. Cl. G06Q 20/10; G06F 3/04847

(52) U.S. Cl. CPC G06Q 20/10; G06F 3/04847

(57) ABSTRACT

Computing platforms, methods, and storage media for automated generation of a data transfer file. Exemplary implementations may: obtain data transfer content parameters and one or more data content parameters associated with a data transfer request; and automatically generate, using a multi-format data transfer file creator, a data transfer file in a data transfer file output format based on the data transfer content parameters and the one or more data transfer format parameters. The data transfer file output format may be among a plurality of supported potential output file formats. Some implementations may include automatically determining the data transfer file output format using a classifier. In contrast to existing automation approaches, exemplary implementations may generate a plurality of different data transfer output file types using the same tool, and may automatically generate a data transfer file in a desired output file format without prior knowledge of the output file type/structure.

### FIELD

The present disclosure relates to data processing, including but not limited to computing platforms, methods, and storage media for automated generation of a data transfer file.

### BACKGROUND

Data transfers often require compliance with specific file formats. For example, predefined guidelines may be provided with respect to data and character requirements for a data transfer file. Even for the same type of data transfer, there may be different guidelines for data transfer file formats or specifications with different data file parameters, such as data file size requirements.

Manual generation of data transfer files can be time consuming and complicated. Current tools that provide some level of automation are limited in their applicability.

Improvements in approaches for automated generation of a data transfer file are desirable.

### BRIEF DESCRIPTION OF THE DRAWINGS

Embodiments of the present disclosure will now be described, by way of example only, with reference to the attached Figures.

FIG. 1 illustrates a system configured for automated generation of a data transfer file, in accordance with one or more embodiments.

FIG. 2 illustrates another system configured for automated generation of a data transfer file, in accordance with one or more embodiments.

FIG. 3 illustrates a method for automated generation of a data transfer file, in accordance with one or more embodiments.

FIG. 4 is an example of a user interface for data transfer file data entry in accordance with one or more embodiments.

FIG. 5 illustrates another method for automated generation of a data transfer file, in accordance with one or more embodiments.

### DETAILED DESCRIPTION

Computing platforms, methods, and storage media for automated generation of a data transfer file are disclosed. Exemplary implementations may: obtain data transfer content parameters associated with a data transfer request; obtain one or more data transfer format parameters associated with the data transfer request; and automatically generate, using a multi-format data transfer file creator supporting a plurality of potential output file formats, a data transfer file in a data transfer file output format based on the data transfer content parameters and based on the one or more data transfer format parameters. The data transfer file output format may be among the plurality of potential output file formats supported by the multi-format data transfer file creator. Some implementations may include automatically determining, using a classifier, the data transfer file output format based on the one or more data transfer format parameters. In contrast to existing automation approaches, exemplary implementations may generate a plurality of different data transfer output file types using the same tool, and may automatically generate a data transfer file in a desired output file format without prior knowledge of the output file parameters.

The present disclosure provides a platform to automatically generate a data transfer file, for example a payment file such as for an electronic funds transfer, without prior knowledge of the output file type/structure, for example prior to generation of, or receipt of, a data transfer request.

There is a technical problem associated with known approaches in that data transfer files often need to be manually created by a person. In some instances, an automation tool may be provided to create a data transfer file in one specific data transfer file format. However, this requires advance knowledge of the data transfer file format, or output file format. Such a known tool, while providing limited automation, is useless if the data transfer file format that may be generated does not match the format that is required. Such a known approach is also hard coded for a specific data transfer file format, such as a payment file format.

One or more embodiments of the present disclosure solve the technical problems by providing a system, apparatus or method that is configured to generate a data transfer file in one or more of a plurality of data transfer file formats, based on received data transfer parameters at the time of data transfer file creation. This allows embodiments of the present disclosure to be used in a number of different scenarios and implementations, without needing to know a required data transfer file format ahead of time. One or more embodiments of the present disclosure also solve a technical problem by providing a tool that is configurable for not only generating a plurality of different file formats, but also for receiving a definition of a new file format, and being able to then generate a data transfer file in the new format that was not previously part of the tool. This provides flexibility as data transfer standards and formats evolve.

One aspect of the present disclosure relates to a computing platform configured for automated generation of a data transfer file. The computing platform may include a non-transient computer-readable storage medium having executable instructions embodied thereon. The computing platform may include one or more hardware processors configured to execute the instructions. The processor(s) may execute the instructions to obtain data transfer content parameters associated with a data transfer request. The processor(s) may execute the instructions to obtain one or more data transfer format parameters associated with the data transfer request. The processor(s) may execute the instructions to automatically generate, using a multi-format data transfer file creator supporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

Another aspect of the present disclosure relates to a method for automated generation of a data transfer file. The method may include obtaining data transfer content parameters associated with a data transfer request. The method may include obtaining one or more data transfer format parameters associated with the data transfer request. The method may include automatically generating, using a multi-format data transfer file creator supporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

Yet another aspect of the present disclosure relates to a non-transient computer-readable storage medium having instructions embodied thereon, the instructions being executable by one or more processors to perform a method for automated generation of a data transfer file. The method may include obtaining data transfer content parameters associated with a data transfer request. The method may include obtaining one or more data transfer format parameters associated with the data transfer request. The method may include automatically generating, using a multi-format data transfer file creatorsupporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

A data transfer may comprise an action of transferring data according to any number of methods for transferring or moving data or digital information from one location to another, such as between different devices, systems, networks, endpoints, locations, etc. A data transfer may be performed using or in accordance with a data transfer protocol, such as file transfer protocol (FTP), HTTP (hyper text transfer protocol), TCP/IP (transmission control protocol/internet protocol).

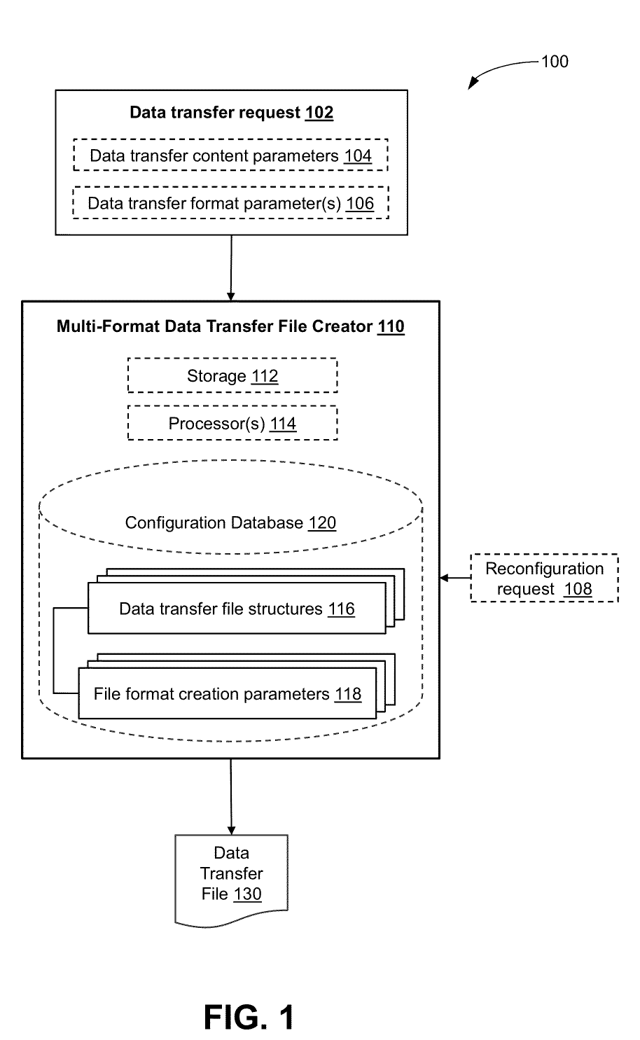

FIG. 1 illustrates a system 100 configured for automated generation of a data transfer file, in accordance with one or more embodiments. In an embodiment, the system 100 may be implemented as an apparatus or as a device. The system 100 comprises a data transfer file creator 110, which may comprise a multi-format data transfer file creator. The data transfer file creator 110 may comprise storage 112 such as a non-transient computer-readable storage medium having executable instructions embodied thereon, such as machine-readable instructions. The data transfer file creator 110 may comprise one or more hardware processors 114 configured by the machine-readable instructions.

The processor(s) 114 may be configured to obtain a data transfer request 102, such as a data transfer request file or data transfer request parameters. For example, a data transfer request file may be received from an end-user in response to initiation of a data transfer request. In another example, the data transfer request file may be automatically generated in response to a developer-user request for testing data. The request for testing data may comprise a request for testing data in the form of data transfers populated by random data and to be created in a valid data transfer format for the purpose of testing a data transfer system or method, which a developer-user is testing. This provides an improvement over manual generation of testing data, which can be time consuming and difficult to accurately generate in a compliant manner. This also provides an improvement over a known computer solution that may be configured to automatically generate an actual data transfer in a single specified format in response to user data, but is not capable of generating testing data in the form of a plurality of test-based data transfers including random data, where the random data in the plurality of test-based data transfers complies with one or more data output format requirements.

The processor(s) 114 may be configured to obtain data transfer content parameters 104 associated with a data transfer, for example associated with a data transfer request or data transfer request file. The data transfer content parameters 104 may comprise details on one or more data types to be included in the content of a data transfer. For example, when a data transfer comprises a file transfer from a sender to a recipient, the data transfer content parameters 104 may comprise one or more of: a file payload, a sender identifier, a sender device identifier, a recipient identifier, a recipient device identifier. For example, when a data transfer comprises an electronic funds transfer, the data transfer content parameters 104 may comprise one or more of: an amount of the electronic funds transfer, a currency associated with the electronic funds transfer, a sender identifier, a recipient identifier, a sender account identifier, a recipient account identifier, and data transfer security credentials.

The processor(s) 114 may be configured to obtain one or more data transfer format parameters 106, also associated with the data transfer, for example associated with a data transfer request or a data transfer request file. While data transfer content parameters 104 relate to the content of the data transfer, the one or more data transfer format parameters 106 relate to the format of the data transfer. For example, when a data transfer comprises a file transfer, the one or more data transfer format parameters 106 may comprise one or more of: a file format identifier, such as PDF (Portable Document Format), EXE (executable file), DOC (word processing document), JPEG (Joint Photographic Experts Group), TIFF (Tagged Image File Format); file payload header format; file payload content format; file size; a sender file size limit; a receiver file size limit. For example, when a data transfer comprises an electronic funds transfer, the data transfer format parameters 106 may comprise one or more of: an electronic funds transfer type, a fixed electronic funds transfer file size (e.g. 80 bytes or 1464 bytes), a unique identifier such as a file creation number. For example, the “CPA 005 1464-byte” format is widely accepted by banks in Canada. An electronic funds transfer type may comprise a SWIFT (Society for Worldwide Interbank Financial Telecommunication) or non-SWIFT electronic funds transfer.

In an embodiment, the multi-format data transfer file creator 110 comprises a plurality of stored data transfer file structures 116 and a plurality of file format creation parameters 118, such as a plurality of sets of file format creation parameters. In an embodiment, each of the plurality of stored data transfer file structures 116 has an associated or corresponding set of file format creation parameters 118. The multi-format data transfer file creator 110 may comprise a configuration database 120 storing the plurality of stored data transfer file structures 116 and the plurality of file format creation parameters 118. In an embodiment, each of the plurality of file format creation parameters 118, or each set of file format creation parameters 118, is associated with one of the plurality of potential output file formats supported by the multi-format data transfer file creator 110. In an embodiment, the database 120 is integrated with, or within, the data transfer file creator 110, as shown in FIG. 1. In an embodiment, the database 120 is in communication with the data transfer file creator 110, and is external to the multi-format data transfer file creator.

In an embodiment, the one or more data transfer format parameters 106 may comprise an identification of the data transfer format, and may not include, or may be independent of, steps or instructions to create an output file in the specified data transfer format. In such an embodiment, the one or more data transfer format parameters 106 may be used to identify the data transfer format, and may be referred to as a data transfer format identifier. Based on an identification of the data transfer format from the one or more data transfer format parameters 106, the multi-format data transfer file creator may obtain, for example from the configuration database 120, the data transfer file structures 116 or the file format creation parameters 118 to enable automatic generation of a data transfer file in the identified or desired output file format.

In an embodiment, the one or more data transfer format parameters 106 may reference a data transfer format specification, which may be stored in the configuration database 120. This may be instead of, or in addition to, the one or more data transfer format parameters 106 identifying the data transfer format. The stored data transfer format specification may include partial or full steps or instructions to create an output file in the identified or specified data transfer format, for example in a set of file format creation parameters 118 associated with a data transfer file structure 116 that has a format that matches the data transfer format specification. In an alternative embodiment, the one or more data transfer format parameters 106 may comprise a data transfer format specification, which may include partial or full steps or instructions to create an output file in the identified or specified data transfer format, which may reduce processing load on the multi-format data transfer file creator 110, thereby providing an improvement in processing capabilities.

In an embodiment, the processor(s) 114 may be configured to automatically generate, for example via or using a multi-format data transfer file creator supporting a plurality of potential output file formats, a data transfer file 130 in a data transfer file output format based on the data transfer content parameters 104 and based on the one or more data transfer format parameters 106. The data transfer file output format may be among the plurality of potential output file formats supported by the multi-format data transfer file creator 110.

For example, suppose the data transfer file creator 110 supports 6 different file formats, and is configured to generate a data transfer file in accordance with those 6 different file formats. In an embodiment, the data transfer file creator 110 shown in FIG. 1 is configured to automatically generate the data transfer file in one of the 6 supported output file formats, based on the data transfer content parameters 104 and on the one or more data transfer format parameters 106. For example, the data transfer file creator 110 may determine that a data transfer format associated with the data transfer content parameters 104 and the one or more data transfer format parameters 106 is one of the 6 potential output file formats in relation to which it is configured to produce output files. one or more data transfer format parameters. The multi-format data transfer file creator 110 may be configured to dynamically generate valid output files, including either random data or valid data, while maintaining required formatting of the data transfer file output format.

In an embodiment, the system 100, which may be implemented as an apparatus, may automatically generate the data transfer file 130 in the data transfer file output format in response to a match identification determination that the data transfer file output format is among the plurality of potential output file formats. In an embodiment, the system may perform a match identification determination to determine whether the data transfer file output format is among the plurality of potential output file formats supported by the system. Such a match identification determination may comprise comparing the one or more data transfer format parameters 106 with stored specifications associated with the plurality of potential output file formats, such as the plurality of data transfer file structures 116 stored in the configuration database 120.

In an embodiment, when the match identification determination determines that the data transfer file output format is not among the plurality of potential output file formats supported by the system, the system aborts the automatic generation of the data transfer file and generates a warning or error message. In such a situation, the system may also be configured to generate a reconfiguration prompt, providing an indication or instructions for a user to generate a reconfiguration request, in order to have a currently unsupported data transfer file format added to the configuration database 120.

The multi-format data transfer file creator 110 may comprise a configurable multi-format data transfer file creator, such that the configuration database 120 is modifiable to add a new data transfer file structure and file format creation parameters associated with a new output file format, to add additional capabilities. This provides an improvement and advantage by permitting the data transfer file creator 110 to automatically generate an output file in one or more additional output file formats compared to those in relation to which it was originally configured. This flexibility and reconfigurability provides a technical improvement over a known computing solution which may only be configured to generate an output file in one specific, fixed format. It also provides flexibility over the original configuration in the configuration database 120, which enables the system 100 to support automatic generation of data transfer files in formats or file structures that are unknown or not yet defined or accepted as standard formats at the time when the configuration database 120 is initially populated.

The multi-format data transfer file creator 110 may be configurable by way of a reconfiguration request 108, such as a database reconfiguration request. The reconfiguration request 108 may comprise a database reconfiguration request file or a database reconfiguration request command. The reconfiguration request 108 may be implemented as configuration database update file, or reconfiguration file, comprising a new data transfer file structure and associated file format creation parameters, according to which the configuration database 120 is to be updated. The multi-format data transfer file creator 110 may receive the reconfiguration request 108, and modify or update the configuration database 120 to include a new data transfer file structure and file format creation parameters associated with a new output file format. The configuration database 120 may be reconfigured based on the received reconfiguration request 108 to support at least one more output file format than the plurality of potential output file formats it was previously configured to support. For example, suppose the multi-format data transfer file creator 110 is originally configured to support creation of 6 output file formats. The multi-format data transfer file creator 110 may reconfigure its configuration database 120 according to the reconfiguration request 108 to expand support from 6 potential output file formats to 7 output file formats. In one or more embodiments, the reconfiguration request 108 may comprise a database reconfiguration request associated with one new output file format, at least one new output file format, or with a plurality of new output file formats.

The configuration database 120 may be reconfigured in accordance with one or more reconfiguration files. For example, the configuration database 120 may be reconfigured according to a first reconfiguration request, and may be subsequently additionally reconfigured according to a second reconfiguration request. A subsequent reconfiguration request may be used to further reconfigure the configuration database associated with the multi-format data transfer file creator 110, compared to its state at the time the subsequent reconfiguration request was received, to further expand the capabilities and the number of output file formats supported. This provides even greater benefit and technical improvement compared to known approaches which are hard coded to only support creation or generation of one dedicated output file format, and have a technical limitation of not supporting reconfiguration.

In an example embodiment, the multi-format data transfer file creator 110 may perform one or more of: receive a data transfer request, process the data transfer request, determine a data transfer file format associated with the data transfer request, initiate data transfer file creation based on the determined data transfer file format, and automatically generate an electronic data transfer file in the determined data transfer file format, for example based on the stored file format creation parameters associated with the determined data transfer file format and/or based on other stored data transfer file structures or parameters associated with the determined data transfer file format. The automatic generation of the electronic data transfer file in the determined data transfer file format may be performed based on the data transfer request and independent of any further user input, such that a user is not involved in the creation of the electronic data transfer file after generation of the data transfer request. The data transfer request may comprise a data transfer request file, and may comprise data transfer content parameters and one or more data transfer format parameters.

The system 100, for example the data transfer file creator 110, may comprise or be in communication with a classifier configured to automatically determine the data transfer file output format based on the one or more data transfer format parameters 106. The classifier may implement a supervised machine learning method. The machine learning method may comprise an algorithm such as: logistic regression, support vector machine, decision trees, artificial neural networks, K-nearest neighbor, random forest, Naive Bayes, gradient boosting or case-based reasoning.

The classifier may implement a supervised machine learning method after having been trained on a set of training data. The training data may comprise a plurality of data transfer files, each having data transfer content parameters and one or more associated data transfer format parameters. The training data may comprise data transfer file structures and/or file format creation parameters, which may be associated with corresponding data transfer output parameters and at least one data transfer format parameter. The training data may be from a training data set, or from previously-processed input and output data, or both. The classifier may be trained to automatically determine the data transfer file output format based on the training data and based on the one or more data transfer format parameters 106, and optionally based on the data transfer content parameters 104. The classifier may be trained to predict whether an obtained data transfer format parameter 106 is associated with an output file format that matches one of the plurality of potential output file formats supported by the data transfer file creator 110. In another embodiment, the data transfer file creator 110 may be configured to provide the one or more data transfer format parameters 106 to a machine learning model, and to obtain a determination of the data transfer file output format from the machine learning model, for example via a machine learning integration module. The system 100 may comprise the machine learning model, or may comprise a machine learning integration module in communication with the machine learning model.

A system and method in accordance with one or more embodiments provides a configurable file generation utility that automates the creation of data transfer files, such as payment files, saving time and effort while ensuring accuracy for various users.

The system 100 may comprise a file generation utility configured to automate the creation of data transfer files in a plurality of specific formats. The system 100 may be configurable, for example via the configuration database 120, to generate files with random or specific values. The configuration database 120 may be customized to specify the layout, size, and value type of each record, and may comprise the plurality of data transfer file structures 116 and the plurality of file format creation parameters 118.

The system 100 enables users to generate random files based on obtained data transfer content parameters 104 and one or more data transfer format parameters 106, eliminating the need for manual input of specific file format creation parameters. Embodiments of the present disclosure can save a significant amount of time and effort for teams, reducing manual work and ensuring accuracy. The system 100 can be used by various users, including quality engineers, developers, business analysts, and production users. The system 100 reduces manual efforts in generating files, resulting in cost savings and quicker file generation, providing a technical improvement over current computer solutions.

One area of implementation is with respect to an Electronic Funds Transfer (EFT) as the data transfer, which requires users to upload files in strict formats (80-Byte or 1464-Byte) with predefined rules and positional requirements. These EFT files, supporting up to 100,000 transactions for 80-byte and 44,000 transactions for 1464 Byte formats, must adhere to specific standards for successful processing. Manually creating these files according to known approaches is a tedious and error-prone process, particularly without specialized tools, making it inefficient to test various combinations and file types supported by EFT.

There are some known tools that may be used to automate generation of a specific data transfer file, such as a payment file. For example, a tool may automate generation of an 80-byte EFT file. However, such a known tool is purpose-built to only generate 80-bit EFT files; other similar tools may be purpose-built to generate only one other specific EFT file format. Using such known approaches, it is necessary to know the data transfer file format ahead of time so that an appropriate purpose-built tool may be used to automatically generate the data transfer file, given the required input data.

A system 100 or data transfer file creator 110 according to one or more embodiments of the present disclosure may be provided as a utility that is built on Java. Such a tool is flexible and accurate, and reduces up to 100% of manual effort, providing an advantage from testing perspective and in production. Since the tool provides automation and may comprise reusable code, the tool may generate a lot of savings compared to the time it would have taken by an individual person to generate a file. The tool is also customizable to future file types, for example based on reconfiguring a configuration database based on a received reconfiguration request, as described earlier.

Embodiments of the present disclosure provide a system implemented as a utility that allows users to input minimal details and generate data transfer files, such as EFT payment files, compliant with predefined rules and positions. The solution supports multiple file types through configurable rule sets, which may be defined in a user-friendly config file. Once the rules are set, the utility dynamically generates valid files, including random data or valid data, while maintaining required formatting.

To further enhance efficiency, in an embodiment the utility integrates with UI automation, enabling runtime generation and modification of files with dynamic updates (e.g. due date, creation date, Originator ID) during automated execution. This improvement has significantly reduced manual effort, saving 500+ hours in testing large combinations of file sizes and types, while improving accuracy and productivity.

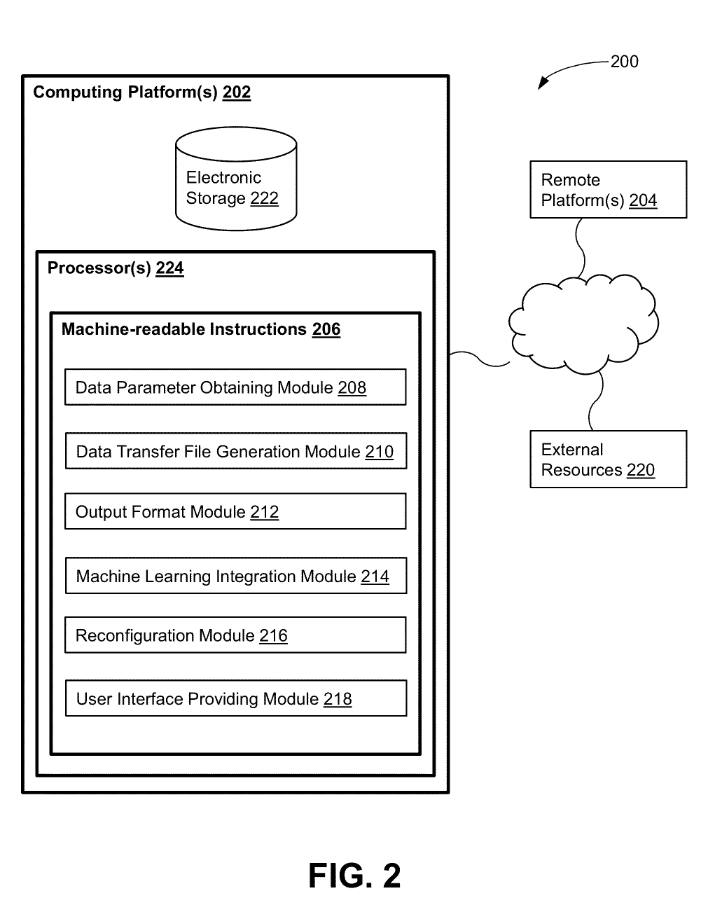

FIG. 2 illustrates a system 200 configured for automated generation of a data transfer file, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of data parameter obtaining module 208, data transfer file generation module 210, output format module 212, machine learning integration module 214, reconfiguration 216, user interface providing module 218, and/or other instruction modules.

Data parameter obtaining module 208 may be configured to obtain data transfer content parameters associated with a data transfer request. Data parameter obtaining module 208 may be configured to obtain one or more data transfer format parameters associated with the data transfer request.

Data transfer file generation module 210 may be configured to automatically generate, using a multi-format data transfer file creator supporting a plurality of potential output file formats, a data transfer file in a data transfer file output format based on the data transfer content parameters and based on the one or more data transfer format parameters. The data transfer file output format may be among the plurality of potential output file formats supported by the multi-format data transfer file creator. Automatically generating the data transfer file may include automatically generating a payment file, for example an electronic funds transfer (EFT) file.

Output format module 212 may be configured to identify the data transfer file output format based on the one or more data transfer format parameters. In an implementation, output format module 212 may be configured to automatically determine, using a classifier, the data transfer file output format based on the one or more data transfer format parameters.

Machine learning integration module 214 may be configured to provide the one or more data transfer format parameters to a machine learning model. In such an implementation, output format module 212 may be configured to obtain a determination of the data transfer file output format from the machine learning model, for example via the machine learning integration module which is in communication with the output format module 212.

Output format module 212 may be configured to determine the data transfer file output format based on the one or more data transfer format parameters. Determining the data transfer file output format may include, when the data transfer file output format received in the obtained data transfer file format specification matches one of a plurality of stored data transfer file specifications, automatically generating the data transfer file in the output data format based on the matching one of the plurality of stored data file transfer specifications.

Reconfiguration module 216 may be configured to obtain or receive a reconfiguration request, which may be implemented as configuration database update file, or reconfiguration file, comprising a new data transfer file structure and associated file format creation parameters, according to which a configuration database is to be updated. The reconfiguration module 216 may receive the reconfiguration request, and modify or update the configuration database to include a new data transfer file structure and file format creation parameters associated with a new output file format. The reconfiguration module 216 may reconfigure the configuration database based on the received reconfiguration request to support at least one more output file format than the plurality of potential output file formats it was previously configured to support.

User interface providing module 218 may be configured to provide a user interface that may include a plurality of user interface elements associated with each of a plurality of data transfer output formats supported. Obtaining the one or more data transfer file format parameters may be performed in response to selection of one of the plurality of user interface elements. User interface providing module 218 may be configured to provide a user interface to receive or obtain a reconfiguration request, which may be processed by the reconfiguration module 216, and to provide an instruction or command to update the multi-format data transfer file creator to include a new data transfer specification based on the reconfiguration request.

In some embodiments, computing platform(s) 202, remote platform(s) 204, and/or external resources 220 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 220 may be operatively linked via some other communication media.

A given remote platform 204 may include one or more processors configured to execute computer program modules. The computer program modules may be configured to enable an expert or user associated with the given remote platform 204 to interface with system 200 and/or external resources 220, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 220 may include sources of information outside of system 200, external entities participating with system 200, and/or other resources. In some embodiments, some or all of the functionality attributed herein to external resources 220 may be provided by resources included in system 200.

Computing platform(s) 202 may include electronic storage 222, one or more processors 224, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 222 may comprise non-transitory storage media that electronically stores information. The electronic storage media of electronic storage 222 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 222 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 222 may include one or more virtual storage resources (e.g., cloud storage, a virtual private network, and/or other virtual storage resources). Electronic storage 222 may store software algorithms, information determined by processor(s) 224, information received from computing platform(s) 202, information received from remote platform(s) 204, and/or other information that enables computing platform(s) 202 to function as described herein.

Processor(s) 224 may be configured to provide information processing capabilities in computing platform(s) 202. As such, processor(s) 224 may include one or more of a digital processor, an analog processor, a digital circuit designed to process information, an analog circuit designed to process information, a state machine, and/or other mechanisms for electronically processing information. Although processor(s) 224 is shown in FIG. 2 as a single entity, this is for illustrative purposes only. In some embodiments, processor(s) 224 may include a plurality of processing units. These processing units may be physically located within the same device, or processor(s) 224 may represent processing functionality of a plurality of devices operating in coordination. Processor(s) 224 may be configured to execute modules 208, 210, 212, 214, 216 and/or 218, and/or other modules. Processor(s) 224 may be configured to execute modules 208, 210, 212, 214, 216 and/or 218, and/or other modules by software; hardware; firmware; some combination of software, hardware, and/or firmware; and/or other mechanisms for configuring processing capabilities on processor(s) 224. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216 and/or 218 are illustrated in FIG. 2 as being implemented within a single processing unit, in embodiments in which processor(s) 224 includes multiple processing units, one or more of modules 208, 210, 212, 214, 216 and/or 218 may be implemented remotely from the other modules. The description of the functionality provided by the different modules 208, 210, 212, 214, 216 and/or 218 described below is for illustrative purposes, and is not intended to be limiting, as any of modules 208, 210, 212, 214, 216 and/or 218 may provide more or less functionality than is described. For example, one or more of modules 208, 210, 212, 214, 216 and/or 218 may be eliminated, and some or all of its functionality may be provided by other ones of modules 208, 210, 212, 214, 216 and/or 218. As another example, processor(s) 224 may be configured to execute one or more additional modules that may perform some or all of the functionality attributed below to one of modules 208, 210, 212, 214, 216 and/or 218.

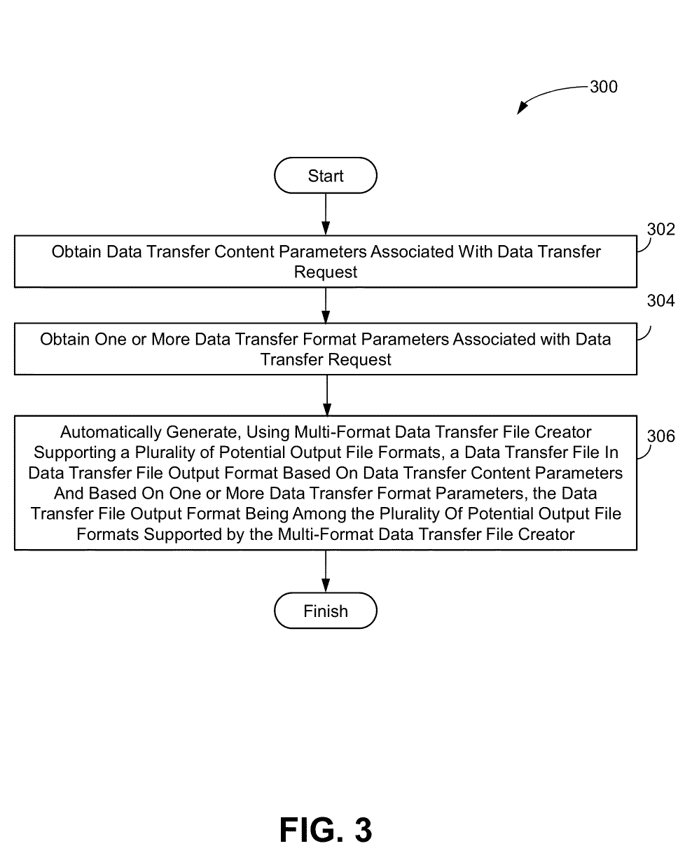

FIG. 3 illustrates a method 300 for automated generation of a data transfer file, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining data transfer content parameters associated with a data transfer request. Operation 302 may be performed by one or more hardware processors configured by machine-readable instructions including a module that is the same as or similar to data parameter obtaining module 208, in accordance with one or more embodiments.

An operation 304 may include obtaining one or more data transfer format parameters associated with the data transfer request. Operation 304 may be performed by one or more hardware processors configured by machine-readable instructions including a module that is the same as or similar to data parameter obtaining module 208, in accordance with one or more embodiments.

An operation 306 may include automatically generating, using a multi-format data transfer file creator supporting a plurality of potential output file formats, a data transfer file in a data transfer file output format based on the data transfer content parameters and based on the one or more data transfer format parameters. The data transfer file output format may be among the plurality of potential output file formats supported by the multi-format data transfer file creator. Operation 306 may be performed by one or more hardware processors configured by machine-readable instructions including a module that is the same as or similar to data transfer file generation module 210, in accordance with one or more embodiments.

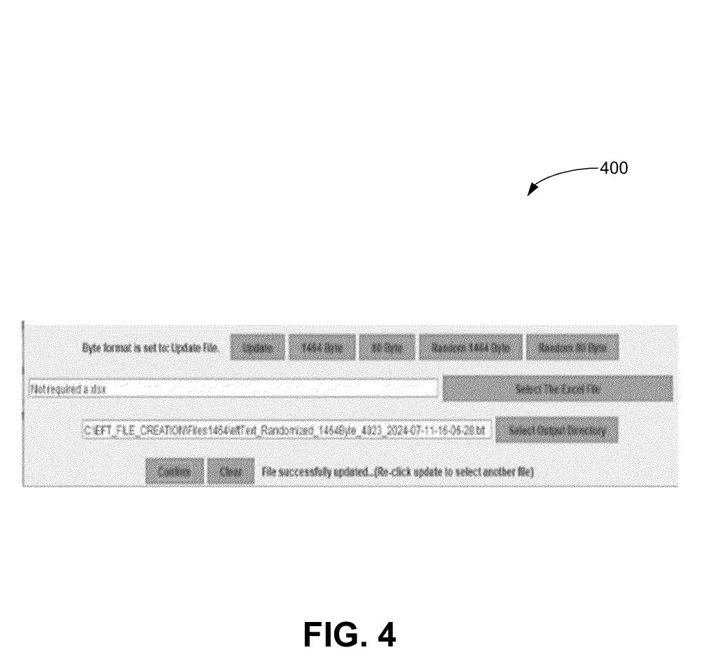

FIG. 4 is an example of a user interface 400 for data transfer file data entry in accordance with one or more embodiments. Embodiments of the present disclosure provide a tool to automate generation of a data transfer file in one or more of a plurality of data transfer file output formats. The tool may be an implementation of a multi-format data transfer file creator supporting a plurality of potential output file formats, as described herein. A user interface such as shown in FIG. 4 may be provided for a user to provide data transfer details, for example payment details for a payment file. The system may receive, via the UI 400, a data transfer request, such as a request to initiate a data transfer, or reconfiguration request, such as a database reconfiguration request. In the example where the data transfer is a payment such as an EFT, the data transfer request may include the data required for the transfer.

A user may select a desired data transfer file format from among a plurality of available data transfer file formats displayed via the UI 400, such as 1464 Byte, 80 Byte, Random 1464 Byte, and Random 80 Byte, as shown in FIG. 4. Since random generation may be used for testing, the “Random 1464 Byte” and “Random 80 Byte” options may be used to generate a data transfer file used for testing the tool, in response to selection or actuation of the corresponding indicator. The “1464 Byte” and “80 Byte” options may be used for generating data transfer files for real user transactions, in response to selection or actuation of the corresponding indicator. The system may be configured to store the different data transfer file formats and their parameters and requirements, for example as part of the data transfer file creator 110 in FIG. 1 or in the configuration database 120 as shown in FIG. 1, or as part of the data transfer file generation module 210 in FIG. 2 or in the electronic storage 222 in FIG. 2. Generating a data transfer file request may be performed in response to actuation or selection of a data transfer format indicator, such as a button or selector as shown in FIG. 4, where a data transfer format parameter for the data transfer request is associated with the selected button or indicator. An indicator or selector may be provided as part of UI 400 to specify a location of a source file containing contents for the data transfer, where the source file may comprise data content parameters.

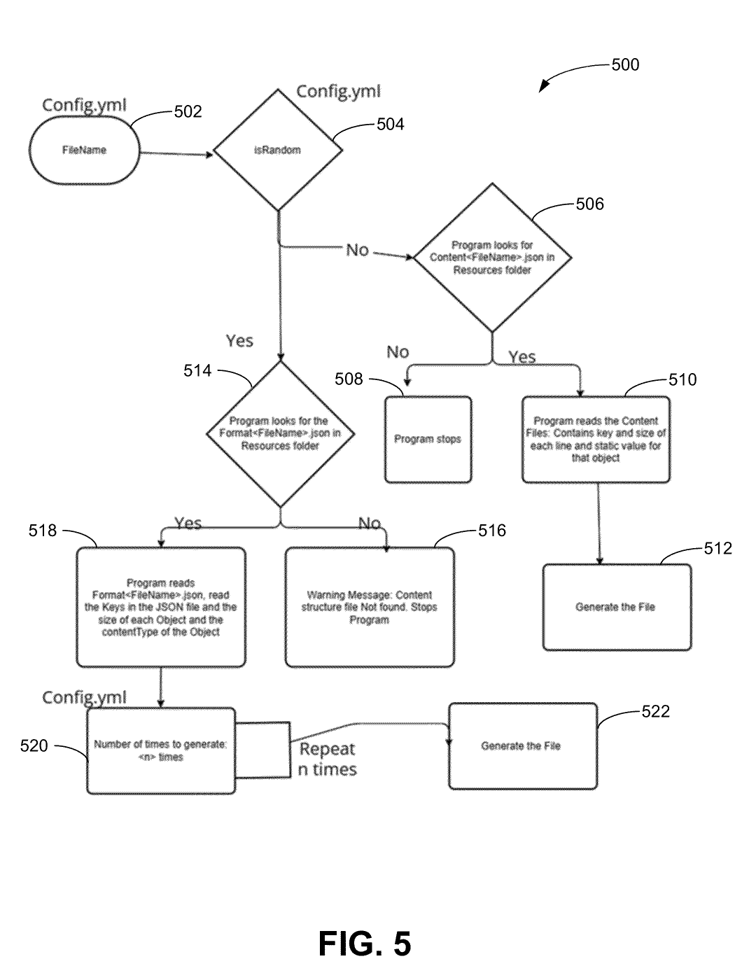

FIG. 5 illustrates another method 500 for automated generation of a data transfer file, in accordance with one or more embodiments. The example of FIG. 5 focuses on a specific example implementation that indicates steps involved whether the generated payment file is a random file generation, or a file generation based on specific user data input. As explained above, random file generation in a specific output file format may be useful for testing a software solution with an output file in the expected format. File generation based on specific user data input may be used when a user desires to generate a data transfer file, such as a payment file associated with a payment that the user desires to send to a recipient or beneficiary.

As shown in FIG. 5, the method may include, at 502, accessing a configuration file, such as Config.yml that may include configuration details relating to a data transfer. The configuration file may, for example comprise a data transfer request file, and may include data transfer content parameters associated with a data transfer request, and one or more data transfer format parameters associated with the data transfer request. At 504, a determination is made whether the data transfer is intended to be based on random data, which would typically be used for testing. If not, the method proceeds at 506 to look for Content<FileName>.json in a Resources folder, which may be an example of obtaining the data transfer content parameters. If the file is successfully located, the method proceeds at 510 to read the content file(s), which may contain key and size of each line and a static value for that object. The method then proceeds at 512 to generate the data transfer file in the desired output file format, and including real content for a data transfer.

If the determination at 504 is that the data transfer is intended to be based on random data, the method proceeds at 514 to look for Format<FileName>.json in a Resources folder, which may be an example of obtaining the one or more data transfer format parameters. If this determination at 514 is not successful, a warning message is generated at 516 indicating that the content structure file is not found, and the process is stopped. If the determination at 514 is successful, the method proceeds at 518 to read Format<FileName>.json, reads the keys in the JSON file and the size of each object and the content type of each object. The method then proceeds at 520 to generate random contents for the data transfer “n” times as specified in the configuration file, for example repeating “n” times. The method then proceeds at 522 to generate the data transfer file in the desired output file format, and including random content for a data transfer that is likely intended for testing.

In accordance with one or more embodiments, the present disclosure provides a system to automatically generate a data transfer file, for example a payment file such as an EFT file, based on specifications in a data transfer request or configuration file and based on user-provided data. The system may be used to automatically generate the EFT file without prior knowledge of the EFT file format. The system may be configured to generate a plurality of different types of EFT files in different formats using the same tool. This is in contrast to existing automation approaches, in which it is only possible to generate a file based on a single EFT format that is hard coded in the tool.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses.

One aspect of the present disclosure relates to a system configured for automated generation of a data transfer file. The system may include one or more hardware processors configured by machine-readable instructions. The processor(s) may be configured to obtain data transfer content parameters associated with a data transfer. The processor(s) may be configured to obtain a data transfer format specification associated with the data transfer request. The processor(s) may be configured to automatically generate, using a multi-format data transfer file creator supporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

In some implementations of the system, the processor(s) may be configured to automatically determine, using a classifier, the data transfer file output format based on the one or more data transfer format parameters.

In some implementations of the system, the processor(s) may be configured to provide the one or more data transfer format parameters to a machine learning model. In some implementations of the system, the processor(s) may be configured to obtain a determination of the data transfer file output format from the machine learning model.

In some implementations of the system, the processor(s) may be configured to identify or determine the data transfer file output format based on the one or more data transfer format parameters.

In some implementations of the system, the processor(s) may be configured to determine the data transfer file output format based on the one or more data transfer format parameters. In some implementations of the system, when the one or more data transfer file output format parameters identifies a data transfer file structure associated with one of a plurality of stored or supported data transfer file structures, the processor(s) may be configured to automatically generate the data transfer file in the output data format based on stored file format creation parameters associated with the identified data transfer file structure.

In some implementations of the system, the processor(s) may be configured to provide a user interface configured to receive or obtain a database reconfiguration request. In some implementations of the system, the processor(s) may be configured to update the multi-format data transfer file creator to include a new data transfer specification based on the obtained database reconfiguration request.

In some implementations of the system, obtaining the data transfer format specification may include obtaining a payment file format specification.

In some implementations of the system, the system may further comprise a configuration database storing a plurality of data transfer file structures and a plurality of sets of file format creation parameters to support creation of the plurality of potential output file formats, the data transfer file output format being among the plurality of potential output file formats supported by the configuration database.

In some implementations of the system, automatically generating the data transfer file may include automatically generating an electronic funds transfer (EFT) file.

In some implementations of the system, the processor(s) may be configured to provide a user interface including a plurality of user interface elements associated with each of the plurality of potential data transfer output formats. In some implementations of the system, obtaining the one or more data transfer file format parameters may be performed in response to selection of one of the plurality of user interface elements.

Another aspect of the present disclosure relates to a processor-implemented method for automated generation of a data transfer file. The method may include obtaining data transfer content parameters associated with a data transfer request. The method may include obtaining one or more data transfer format parameters associated with the data transfer request. The method may include automatically generating, using a multi-format data transfer file creator supporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

Some implementations of the method may include automatically determining, using a classifier, the data transfer file output format based on the one or more data transfer format parameters.

Some implementations of the method may include providing the one or more data transfer format parameters to a machine learning model. Some implementations of the method may include obtaining a determination of the data transfer file output format from the machine learning model.

Some implementations of the method may include identifying or determining the data transfer file output format based on data contained in the one or more data transfer format parameters.

Some implementations of the method may include, when the one or more data transfer file output format parameters identifies a data transfer file structure associated with one of a plurality of stored or supported data transfer file structures, automatically generating the data transfer file in the output data format based on stored file format creation parameters associated with the identified data transfer file structure.

Some implementations of the method may include providing a user interface configured to receive or obtain a database reconfiguration request. Some implementations of the method may include updating the multi-format data transfer file creator to include a new data transfer specification based on the obtained database reconfiguration request.

In some implementations of the method, obtaining the one or more data transfer format parameters may include obtaining a payment file format specification.

In some implementations of the method, automatically generating the data transfer file may include automatically generating an electronic funds transfer (EFT) file.

Some implementations of the method may include providing a user interface including a plurality of user interface elements associated with each of a plurality of data transfer output formats. In some implementations of the method, obtaining the data transfer file format specification may be performed in response to selection of one of the plurality of user interface elements.

Yet another aspect of the present disclosure relates to a non-transient computer-readable storage medium having instructions embodied thereon, the instructions being executable by one or more processors to perform a method for automated generation of a data transfer file. The method may include obtaining data transfer content parameters associated with a data transfer request. The method may include obtaining one or more data transfer format parameters associated with the data transfer request. The method may include automatically generating, using a multi-format data transfer file creator supporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

In some implementations of the computer-readable storage medium, the method may include automatically determining, using a classifier, the data transfer file output format based on the one or more data transfer format parameters.

In some implementations of the computer-readable storage medium, the method may include providing the one or more data transfer format parameters to a machine learning model. Some implementations of the method may include obtaining a determination of the data transfer file output format from the machine learning model.

In some implementations of the computer-readable storage medium, the method may include identifying or determining the data transfer file output format based on data contained in the one or more data transfer format parameters.

In some implementations of the computer-readable storage medium, the method may include, when the one or more data transfer file output format parameters identifies a data transfer file structure associated with one of a plurality of stored or supported data transfer file structures, automatically generating the data transfer file in the output data format based on stored file format creation parameters associated with the identified data transfer file structure.

In some implementations of the computer-readable storage medium, the method may include providing a user interface configured to receive or obtain a database reconfiguration request. Some implementations of the method may include updating the multi-format data transfer file creator to include a new data transfer specification based on the obtained database reconfiguration request.

In some implementations of the computer-readable storage medium, obtaining the one or more data transfer format parameters may include obtaining a payment file format specification.

In some implementations of the computer-readable storage medium, automatically generating the data transfer file may include automatically generating an electronic funds transfer (EFT) file.

In some implementations of the computer-readable storage medium, the method may providing a user interface including a plurality of user interface elements associated with each of a plurality of data transfer output formats. In some implementations of the computer-readable storage medium, obtaining the data transfer file format specification may be performed in response to selection of one of the plurality of user interface elements.

Even another aspect of the present disclosure relates to a computing platform configured for automated generation of a data transfer file. The computing platform may include a non-transient computer-readable storage medium having executable instructions embodied thereon. The computing platform may include one or more hardware processors configured to execute the instructions. The processor(s) may be configured to obtain data transfer content parameters associated with a data transfer. The processor(s) may be configured to obtain a data transfer format specification associated with the data transfer request. The processor(s) may be configured to automatically generate, using a multi-format data transfer file creator supporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

In some implementations of the computing platform, the processor(s) may be configured to automatically determine, using a classifier, the data transfer file output format based on the one or more data transfer format parameters.

In some implementations of the computing platform, the processor(s) may be configured to provide the one or more data transfer format parameters to a machine learning model. In some implementations of the system, the processor(s) may be configured to obtain a determination of the data transfer file output format from the machine learning model.

In some implementations of the computing platform, the processor(s) may be configured to identify or determine the data transfer file output format based on the one or more data transfer format parameters.

In some implementations of the computing platform, the processor(s) may be configured to determine the data transfer file output format based on the one or more data transfer format parameters.

In some implementations of the computing platform, when the one or more data transfer file output format parameters identifies a data transfer file structure associated with one of a plurality of stored or supported data transfer file structures, the processor(s) may be configured to automatically generate the data transfer file in the output data format based on stored file format creation parameters associated with the identified data transfer file structure.

In some implementations of the computing platform, the processor(s) may be configured to provide a user interface configured to receive or obtain a database reconfiguration request. In some implementations of the system, the processor(s) may be configured to update the multi-format data transfer file creator to include a new data transfer specification based on the obtained database reconfiguration request.

In some implementations of the computing platform, obtaining the data transfer format specification may include obtaining a payment file format specification.

In some implementations of the computing platform, the computing platform may further comprise a configuration database storing a plurality of data transfer file structures and a plurality of sets of file format creation parameters to support creation of the plurality of potential output file formats, the data transfer file output format being among the plurality of potential output file formats supported by the configuration database.

In some implementations of the computing platform, automatically generating the data transfer file may include automatically generating an electronic funds transfer (EFT) file.

In some implementations of the computing platform, the processor(s) may be configured to provide a user interface including a plurality of user interface elements associated with each of the plurality of potential data transfer output formats. In some implementations of the system, obtaining the one or more data transfer file format parameters may be performed in response to selection of one of the plurality of user interface elements.

A further aspect of the present disclosure provides an apparatus configured for automated generation of a data transfer file, the apparatus comprising: a configuration database storing a plurality of data transfer file structures and a plurality of sets of file format creation parameters to support creation of a plurality of potential output file formats; a non-transient computer-readable storage medium having executable instructions embodied thereon; and one or more hardware processors configured to execute the instructions to: obtain data transfer content parameters associated with a data transfer request; obtain one or more data transfer format parameters associated with the data transfer request; and automatically generate a data transfer file in a data transfer file output format based on the data transfer content parameters and based on the one or more data transfer format parameters, the data transfer file output format being among a plurality of potential output file formats supported by the configuration database.

What is claimed is:

1. An apparatus configured for automated generation of a data transfer file, the apparatus comprising:
a non-transient computer-readable storage medium having executable instructions embodied thereon; and
one or more hardware processors configured to execute the instructions to:
obtain data transfer content parameters associated with a data transfer request;
obtain one or more data transfer format parameters associated with the data transfer request; and
automatically generate, using a multi-format data transfer file creator supporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

2. The apparatus of claim 1 wherein the one or more hardware processors are further configured to execute the instructions to:
automatically determine, using a classifier, the data transfer file output format based on the one or more data transfer format parameters.

3. The apparatus of claim 1 wherein the one or more hardware processors are further configured to execute the instructions to:
provide the one or more data transfer format parameters to a machine learning model; and
obtain a determination of the data transfer file output format from the machine learning model.

4. The apparatus of claim 1 wherein the one or more hardware processors are further configured to execute the instructions to:
identify the data transfer file output format based on the one or more data transfer format parameters.

5. The apparatus of claim 4 wherein the one or more hardware processors are further configured to execute the instructions to:
when the one or more data transfer file parameters identifies a data transfer file structure associated with one of a plurality of stored data transfer file structures:
automatically generate the data transfer file in the output data format based on stored file format creation parameters associated with the identified data transfer file structure.

6. The apparatus of claim 1 wherein the one or more hardware processors are further configured to execute the instructions to:
obtain a database reconfiguration request; and
provide a user interface configured to update the multi-format data transfer file creator to include a newly supported data transfer file structure based on the obtained database reconfiguration request.

7. The apparatus of claim 1 further comprising:
a configuration database storing a plurality of data transfer file structures and a plurality of sets of file format creation parameters to support creation of the plurality of potential output file formats, the data transfer file output format being among the plurality of potential output file formats supported by the configuration database.

8. The apparatus of claim 1 wherein automatically generating the data transfer file comprises automatically generating an electronic funds transfer (EFT) file.

9. The apparatus of claim 1 wherein the one or more hardware processors are further configured to execute the instructions to:
provide a user interface including a plurality of user interface elements associated with each of the plurality of potential data transfer output file formats,
wherein obtaining the one or more data transfer file format parameters is performed in response to selection of one of the plurality of user interface elements.

10. A method of automated generation of a data transfer file, comprising:
obtaining data transfer content parameters associated with a data transfer request;
obtaining one or more data transfer format parameters associated with the data transfer request; and
automatically generating, using a multi-format data transfer file creator supporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

11. The method of claim 10 further comprising:
automatically determining, using a classifier, the data transfer file output format based on the one or more data transfer format parameters.

12. The method of claim 10 further comprising:
providing the one or more data transfer format parameters to a machine learning model; and
obtaining a determination of the data transfer file output format from the machine learning model.

13. The method of claim 10 further comprising:
identifying the data transfer file output format based on the one or more data transfer format parameters.

14. The method of claim 13 further comprising:
when the one or more data transfer format parameters identifies a data transfer file structure associated with one of a plurality of supported data transfer file structures:
automatically generating the data transfer file in the output data format based on stored file format creation parameters associated with the identified data transfer file structure.

15. The method of claim 10 further comprising:
obtaining a database reconfiguration request; and
providing a user interface configured to update the multi-format data transfer file creator to include a newly supported data transfer file structure based on the obtained database reconfiguration request.

16. The method of claim 10 wherein obtaining the data transfer format specification comprises obtaining a payment file format specification.

17. The method of claim 10 wherein automatically generating the data transfer file comprises automatically generating an electronic funds transfer (EFT) file.

18. The method of claim 10 further comprising:
providing a user interface including a plurality of user interface elements associated with each of a plurality of data transfer output formats,
wherein obtaining the data transfer file format specification is performed in response to selection of one of the plurality of user interface elements.

19. A non-transient computer-readable storage medium having instructions embodied thereon, the instructions being executable by one or more processors to perform a method of enabling automated threat model assessment for a software solution, comprising:
obtaining data transfer content parameters associated with a data transfer request;
obtaining one or more data transfer format parameters associated with the data transfer request; and
automatically generating, using a multi-format data transfer file creator supporting a plurality of potential output file formats, a data transfer file in a data transfer file output format based on the data transfer content parameters and based on the one or more data transfer format parameters, the data transfer file output format being among the plurality of potential output file formats supported by the multi-format data transfer file creator.

20. The non-transient computer-readable storage medium of claim 19 wherein the method further comprises:
automatically determining, using a classifier, the data transfer file output format based on the one or more data transfer format parameters.
